(19) United States
(12) Patent Application Publication
(10) Pub. No.: US 2026/0037851 A1
(43) Pub. Date: Feb. 5, 2026

(54) Storage System for Simulation of Quantum Circuit

(71) Applicant: SEOUL NATIONAL UNIVERSITY R&DB FOUNDATION, Seoul (KR)

(72) Inventors: Jae Jin LEE, Seoul (KR); Dae Young PARK, Seoul (KR); Hee Hoon KIM, Seoul (KR); Jin Pyo KIM, Seoul (KR)

(73) Assignee: SEOUL NATIONAL UNIVERSITY R&DB FOUNDATION, Seoul (KR)

(21) Appl. No.: 18/640,765

(22) Filed: Apr. 19, 2024

Related U.S. Application Data
(63) Continuation of application No. PCT/KR2022/005229, filed on Apr. 11, 2022.

(30) Foreign Application Priority Data
Oct. 21, 2021 (KR) 10-2021-0141159
Apr. 7, 2022 (KR) 10-2022-0043557

(51) Int. Cl. G06N 10/80; G06F 3/06; G06N 10/20

(52) U.S. Cl. CPC G06N 10/80; G06F 3/061; G06F 3/0644; G06F 3/0685; G06N 10/20

(57) ABSTRACT

A storage system for simulating a quantum circuit includes multiple storage devices, wherein the multiple storage devices may be connected to a host device through a redundant array of independent disks (RAID) expansion card and may read data consecutively stored in a first storage device among the multiple storage devices to a main memory with a single access to the first storage device in response to a data read request for an operation in the main memory of the host device.

### CROSS-REFERENCE TO RELATED APPLICATION

This application is a by-pass continuation of International Application No. PCT/KR2022/005229, filed on Apr. 11, 2022 in the Korean Intellectual Property Receiving Office, which is based on and claims priority to Korean Application No. 10-2021-0141159, filed on Oct. 21, 2021 and No. 10-2022-0043557, filed on Apr. 7, 2022 in the Korean Intellectual Property Office, the entire disclosures of which are incorporated herein by reference.

### BACKGROUND

The present disclosure relates to a storage system, and more particularly, to a storage system for executing an algorithm for a quantum circuit by using a classical computer.

Quantum computing is a computing paradigm that uses a quantum mechanical phenomenon, such as quantum superposition and entanglement. A minimum unit of the quantum computing is a qubit which may represent a superposed state of 0 and 1 unlike a bit of the classical computing. A computational model of the quantum computing is called a quantum circuit, and the quantum circuit is a set of N qubits and a series of quantum gates that act on the qubits.

In order for a classical computer to represent quantum information, an exponentially increasing memory is required. A state expressed by N qubits may be represented by a total of 2n amplitudes. Each amplitude is expressed as a complex number and may generally be represented by 16 bytes of memory. Therefore, to simulate a quantum circuit including N qubits, a storage space of 2^{(N+4)} bytes is required. Exponentially increasing memory requirements are the biggest barrier to simulation of a quantum circuit.

The existing quantum circuit simulation technology uses a supercomputer with a scale of thousands to tens of thousands of nodes to handle enormous memory requirements. However, the technology currently has difficulty in simulating a quantum circuit of 50 qubits or more, even when the largest supercomputer is used. In addition, using the supercomputer has the disadvantage of requiring enormous costs and making it difficult for ordinary users to even access the supercomputer.

### SUMMARY

Embodiments may provide an expanded storage system that performs large-scale operations and uses a storage device, which is cheaper and has a larger storage capacity than a memory to perform simulation of a quantum circuit, such as a hard disk drive (HDD), a solid state drive (SSD), or nonvolatile memory express (NVMe).

Embodiments may provide a storage system including multiple high-capacity storage devices that meet exponentially increasing memory requirements for simulation of a quantum circuit without using a supercomputer.

Other aspects, features, and advantages other than above description will become apparent from following drawings, claims, and detailed description of the present disclosure.

According to an aspect of embodiments, a storage system includes multiple storage devices, wherein the multiple storage devices may be connected to a host device through a redundant array of independent disks (RAID) expansion card and may read data consecutively stored in a first storage device among the multiple storage devices to a main memory with a single access to the first storage device in response to a data read request for an operation in the main memory of the host device.

According to another aspect of embodiments, an operation method using multiple storage devices may include requesting, by a host device, read of data for an operation in a main memory, and reading data consecutively stored in a first storage device among the multiple storage devices to the main memory with a single access to the first storage device, wherein the multiple storage devices may be connected to the host device through a redundant array of independent disks (RAID) expansion card.

### BRIEF DESCRIPTION OF THE DRAWINGS

Embodiments of the inventive concept will be more clearly understood from the following detailed description taken in conjunction with the accompanying drawings in which:

FIG. 1 is a block diagram of an electronic device including a storage system, according to an embodiment;

FIG. 2 is an example of an architecture of a storage system according to an embodiment;

FIG. 3A is an implementation example of a storage system using a hard disk drive (HDD), according to an embodiment;

FIG. 3B is an implementation example of a storage system using a solid state drive (SSD), according to an embodiment;

FIG. 3C is an implementation example of a storage system using nonvolatile memory express (NVMe), according to an embodiment; and

FIG. 4 is a flowchart of a method of simulating a quantum circuit, according to an embodiment.

### DETAILED DESCRIPTION OF THE EMBODIMENTS

Hereinafter, embodiments will be described in detail with reference to the attached drawings. However, the scope of rights is not limited by the embodiments. The same reference numerals in each drawing indicate the same members.

Terms used in the description below have been selected to be general and universal in the related technical field, but there may be other terms depending on technological developments and/or changes, preferences of customary technicians, and so on. Accordingly, the terms used in the description below should not be understood as limiting the technical idea and should be understood as illustrative terms for describing embodiments.

Also, in certain cases, there are terms randomly selected by the applicant, and in this case, the detailed meaning will be described in the relevant description. Therefore, the terms used in the description below should be understood based on the meaning of the terms and the overall content of the specification, not just the names of the terms.

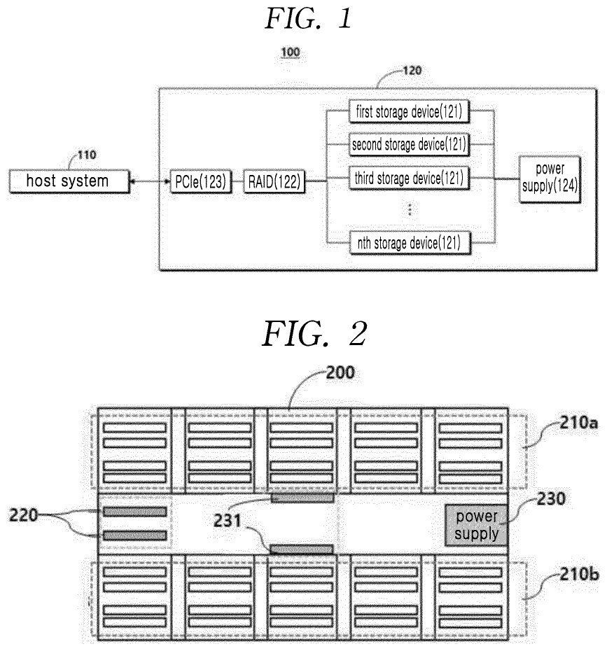

FIG. 1 is a block diagram of an electronic device 100 including a storage system 120, according to an embodiment. The electronic device 100 may include a host system 110 and the storage system 120. The host system 110 performs an actual operation and includes different systems including a central processing unit (CPU), a main memory, and a graphics processing unit (GPU). The storage system 120 includes multiple storage devices 121, and the multiple storage devices include, for example, a hard disk drive (HDD), a solid state drive (SSD), nonvolatile memory express (NVMe), and so on. The multiple storage devices 121 are connected to a power supply 124. The storage system 120 may be connected to the host system 110 through a redundant array of independent disks (RAID) card 122 and a peripheral component interconnect express (PCIe) slot 123. The RAID card 122 may be used to connect multiple arrays of independent disks to a host CPU and mainly operate by being connected to the PCIe slot 123. The PCIe slot 123 refers to a serial interface for input and output.

The electronic device 100 may read, from the storage system 120, data corresponding to a partial execution unit obtained by partitioning a large-scale operation into executable units in a main memory and may write operation result data to the storage system 120 after a partial operation. In one embodiment, the electronic device 100 may partition a quantum circuit into several sub-circuits through a sub-circuit partitioning process to simulate the quantum circuit and sequentially simulate all sub-circuits in units of sub-circuits. In one embodiment, the electronic device 100 may read, for example, learning data related to a convolution operation, from the storage system 120, in units executable in the main memory to execute a deep learning algorithm and may write operation result data to the storage system 120 after each convolution operation.

FIG. 2 is an example of an architecture of the storage system 200 according to an embodiment.

The multiple storage devices 121 may be coupled to modules 210a and 210b. The storage system 200 may have a structure including five separate modules 210a and 210b. The modules 210a and 210b may each include four storage devices (for example, a HDD, a SSD, and NVMe), and the architecture illustrated in FIG. 2 may include 40 storage devices. A storage device attached to each of the modules 210a and 210b may support an appropriate interface. For example, an HDD may be attached to a device that supports a small astronomy satellite-3 (SAS3) or serial advanced technology attachment-3 (SATA3). An SSD attached to each module has to support SAS3 or STAT3. An NVMe attached to each module has to support an M.2 or U.2 interface. Multiple storage devices may be mixed in the storage system 200. However, when storage devices of the same type are attached to the storage system 200, the best performance may be achieved.

A reference numeral 220 indicates a PCIe expansion card and a RAID expansion card connected thereto. A PCIe expansion card 220 operates by receiving the power provided from a power supply 230. A RAID expansion card 220 may support SAS3 and include at least one external port and at least five internal ports. The multiple storage devices 121 may be connected to a RAID card or another storage system.

Panels 231 to which a direct current (DC) converter is attached are provided to supply power from the power supply 230 to the multiple storage devices 121. The panels 231 may each be attached to four DC converters, each converting 12 V to 5 V. The storage system 200 includes the power supply 230. The power supply 230 supplies power to the multiple storage devices 210a and 210b and the panels 231 to which DC converters are respectively attached.

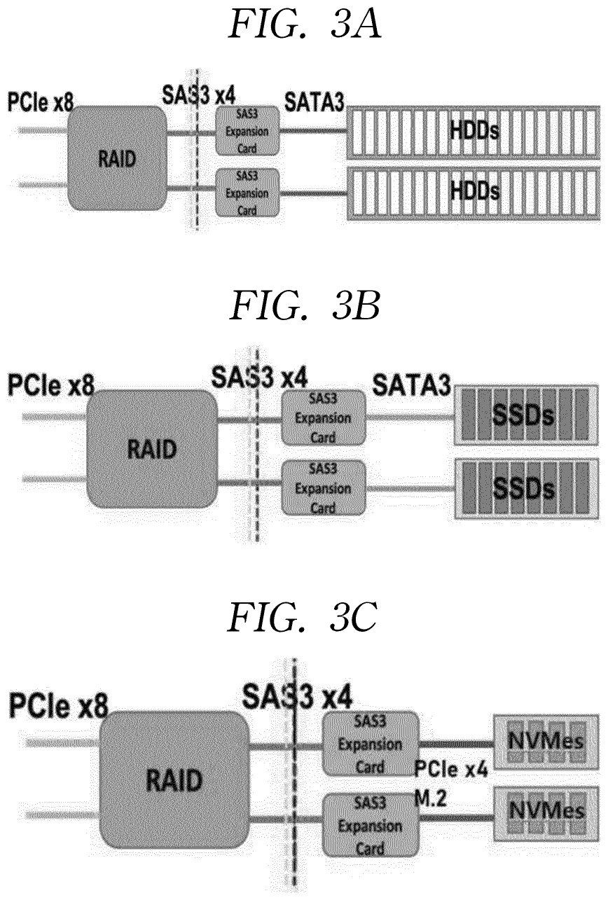

FIG. 3A is an implementation example of a storage system using an HDD, according to an embodiment.

The storage system 120 includes two SAS3 expansion cards and 40 SATA3 HDDs. In this case, the SAS3 expansion cards may each have five SFF8643 internal ports and more, and the SFF8643 internal ports may each be connected to four HDDs through SFF8643-4xSATA3 cables. As a result, each of the two SAS3 expansion cards may be connected to 20 HDDs through five ports, and the two SAS3 expansion cards may be connected to a total of 40 HDDs. In order for the storage system 120 to be connected to the host system 110, a RAID card may be attached to PCIe x8 lane.

The RAID card has two or more SFF8644 external ports. The RAID card is connected to the SAS3 expansion card through an SFF8644-SFF8644 cable. The RAID card may be directly and physically attached to the host system 110, and the SAS3 expansion card may be directly and physically connected to multiple storage devices.

The storage system 120 of FIG. 3A is designed to provide sufficient performance to the host system 110 by calculating a bandwidth of each communication interface. A bandwidth of a SATA3 HDD is ˜220 MB/s, a bandwidth of a SATA3 connection is 768 MB/s, and a bandwidth of a SAS3x4 (for example, SFF8643 or SFF8644) connection is 6 GB/s. Therefore, a connection of one SATA3 provides a sufficient bandwidth for one HDD. Also, a connection of one SAS3x4 provides a sufficient bandwidth for 20 HDDs. Therefore, connections of two SAS3x4 provide a sufficient bandwidth for 40 HDDs.

FIG. 3B is an implementation example of a storage system using an SSD, according to an embodiment.

The storage system 120 includes two SAS3 expansion cards and 16 SSDs. The two SAS3 expansion cards may each include two or more SFF8643 internal ports, and each port may be connected to four SSDs through SFF8643-4xSATA3 cables. As a result, each of the two SAS3 expansion cards may be connected to eight SSDs through two ports, and the two SAS3 expansion cards may be connect to a total of 16 SSDs. A connection between the host system 110 and the storage system 120 is the same as in the case of FIG. 3A (SFF8644-SFF8644).

In the embodiment of FIG. 3B, a bandwidth of the SSD is ˜550 MB/s, and SAS3x4 of 6 GB/s provides a sufficient bandwidth for eight SSDs. Finally, connections of two SAS3x4 provide a sufficient bandwidth for 16 SSDs.

FIG. 3C is an implementation example of a storage system using NVMe, according to an embodiment.

The storage system 120 includes two SAS3 expansion cards and eight M.2 NVMes. Each of the two SAS3 expansion cards includes four or more SFF8643 internal ports, and each port may be connected to one NVMe through an SFF8643-M.2 cable. As a result, the two SAS3 expansion cards may each be connected to four NVMes through four ports, and the two SAS3 expansion cards may be connected to a total of eight NVMes. A connection between the host system 110 and the storage system 120 is the same as in the case of FIG. 3A (SFF8644-SFF8644).

However, unlike the embodiment of FIG. 3A including HDDs, a performance bottleneck occurs in a bandwidth of the connection of SAS3 x4 connecting a RAID card to the SAS3 expansion card in FIG. 3C. This is because a bandwidth of the latest NVMe device is ˜6 GB/s, which is much higher than a bandwidth of an HDD. However, a RAID configuration may reduce the possibility of data loss due to failure of a storage device. Also, because NVMe has a much shorter lifespan than an HDD and the total size of write operations is limited, the RAID configuration has an advantage of using for a longer period of time by distributing the write operations. In various embodiments, an architecture may be designed by selecting an appropriate storage device depending on the purpose and functionality of a host system.

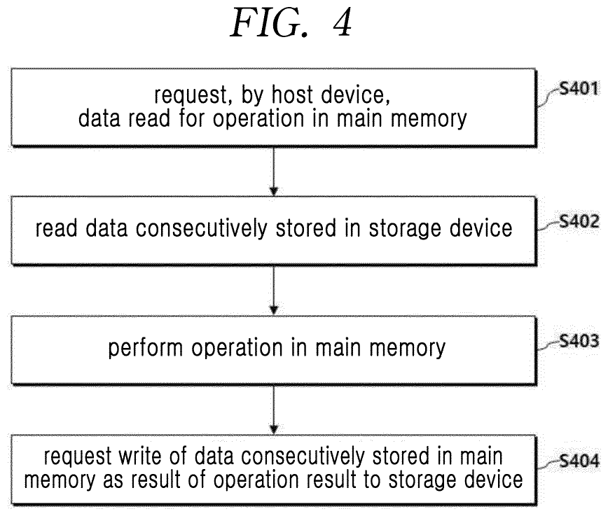

FIG. 4 is a flowchart of an operation method using multiple storage devices, according to an embodiment.

In step S401, a host device may request data read for operation in a main memory. In one embodiment, the host device may request probability amplitude data read for one or more sub-circuits stored in multiple storage devices to simulate a quantum circuit in one or more partitioned sub-circuit units.

In step S402, the probability amplitude data of each sub-circuit consecutively stored in one of the multiple storage devices may be read to the main memory with a single access to the storage device. The probability amplitude data of each sub-circuit is consecutively stored in one of the multiple storage devices, and the probability amplitude data may be read consecutively with a single access to the storage device according to a data request. During simulation (for example, a gate operation) for each sub-circuit, the host device does not require additional access to the storage device for execution of a corresponding sub-circuit.

In step S403, the host device may perform an operation in a main memory. In one embodiment, the host device may perform each simulation for one or more sub-circuits obtained by partitioning a quantum circuit, and a probability amplitude data value for the sub-circuit may be updated according to a quantum gate operation. In response to execution of a block permutation operation for each of sub-circuits which is performed by the host device, a storage device may change the layout of data of each sub-circuit. The host device according to an embodiment may convert a permutation operation for each of one or more sub-circuits into a first-stage in-memory permutation operation, a second-stage block permutation operation, and a third-stage in-memory permutation operation to sequentially perform the operations. In one embodiment, a main memory may change data layouts of the first-stage in-memory permutation operation and the third-stage in-memory permutation operation, and a storage device may change a data layout of the second-stage block permutation operation. By fixing a minimum unit of access operations for all storage devices to be relatively large by using the third-stage permutation operation, a bandwidth of the storage device may be utilized much better than performing a simple memory access operation. However, an additional memory operation is required for two in-memory permutation operations, which is an access to a memory and is much faster than an access to a storage device, and accordingly, when considering the total operation time, it is more efficient to apply a third-stage permutation operation.

In step S404, the host device may request write of the data consecutively stored in a main memory as a result of an operation result to the storage device. In one embodiment, the host device may consecutively write an updated value of probability amplitude data stored in the main memory to the storage device with only one access as a result of simulation of each sub-circuit of a quantum circuit.

In one embodiment, multiple storage devices may include any one type among an HDD, an SSD, and NVMe. That is, the multiple storage devices may include storage devices of one type as illustrated in FIGS. 3A to 3C. In another embodiment, the multiple storage devices may include one or more types of an HDD, an SSD, and NVMe. It is obvious to those skilled in the art that the multiple storage devices may be designed by using various devices in various embodiments without being limited to the HDD, SSD, or NVMe.

In one embodiment, a step of loading the probability amplitude data for a next sub-circuit of the first sub-circuit into a main memory while the host device performs an operation of the first sub-circuit among one or more sub-circuits may be further provided. Because the partitioned sub-circuits are simulated sequentially, the host device may know an exact position value of the probability amplitude data for a sub-circuit to be used next to a currently executing sub-circuit. Therefore, the host device may apply a prefetching technique to optimize the simulation. The host device may load the probability amplitude data for the second sub-circuit to be executed after the currently executing first sub-circuit into the main memory in advance, that is, during execution of the first sub-circuit.

A dynamic random access memory (DRAM) device used in the conventional technology 297 is more expensive than an HDD based on cost per gigabyte (GB), and even the world's most powerful supercomputer in 2021 may not perform simulation of a 50-qubit quantum circuit. However, according to embodiments of the present disclosure, in order to simulate a quantum circuit with a size of 50 qubits, a storage system may be configured with only 16 storage devices, for example, HDDs of 80x16 TB.

According to embodiments, even a storage system including only low-cost and high-capacity storage devices may perform large-scale operations, such as quantum circuit simulation and deep learning.

The embodiments described above may be implemented by hardware components, software components, and/or a combination of hardware components and software components. For example, the device, method, and components described in the embodiments may each be implemented by one or more general-purpose computers or special-purpose computers, such as a processor, a controller, an arithmetic logic unit (ALU), a digital signal processor, a microcontroller, a field programmable gate array (FPGA), a programmable logic unit (PLU), a microprocessor, or any other device that may execute and respond to instructions. A processing device may execute an operating system (OS) and one or more software applications that run on the operating system. Also, a processing device may also access, store, operate, process, and generate data in response to execution of software. For the sake of ease of understanding, a single processing device may be described as being used, but those skilled in the art will understand that a processing device includes multiple processing elements and/or multiple types of processing elements. For example, a processing device may include multiple processors or one processor and one controller. Also, other processing configurations, such as parallel processors, may be implemented.

Software may include a computer program, code, instructions, or a combination thereof, which may configure a processing device to operate as desired or may independently or collectively command the processing device. Software and/or data may be embodied permanently or temporarily in any type of a machine, component, a physical device, virtual equipment, a computer storage medium or device, and a signal wave to be transmitted to be interpreted by or to provide instructions or data to a processing device. Software may be distributed over networked computer systems and stored or executed in a distributed manner. Software and data may be stored in one or more computer-readable recording media.

The method according to the embodiment may be implemented in the form of program instructions that may be executed by various computer devices and may be recorded on a computer-readable medium. The computer-readable medium may include program instructions, data files, data structures, or a combination thereof. Program instructions recorded on a medium may be specially designed and configured for the embodiment or may be known and available to those skilled in the art of computer software. Computer-readable recording media include, for example, magnetic media such as hard disks, floppy disks, and magnetic tapes, optical media such as a compact disk-read only memory (CD-ROM) and a digital video disk_(DVD), magneto-optical media such as floptical disks, and hardware devices specifically configured to store and execute program instructions, such as read only memory (ROM), random access memory (RAM), and flash memory. Program instructions include, for example, machine language code that are generated by a compiler and a high-level language code that may be executed by a computer by using an interpreter and so on. The hardware devices described above may be configured to operate as one or more software modules to perform the operations of the embodiments, and vice versa.

As described above, although embodiments are described with limited examples and drawings, various modifications and changes may be made by those skilled in the art from the above description. For example, although the described technologies are performed in a different order from the described method, components of the described system, structure, device, circuit, and so on are coupled or combined in a different form from the described method, and/or the components are replaced or substituted with other components or equivalents, appropriate results may be achieved. Therefore, other implementations, other embodiments, and equivalents of the claims also fall within the scope of the claims described below.

What is claimed is:

1. A storage system comprising:
multiple storage devices,
wherein the multiple storage devices are connected to a host device through a redundant array of independent disks (RAID) expansion card, and
reads data consecutively stored in a first storage device among the multiple storage devices to a main memory with a single access to the first storage device in response to a data read request for an operation in the main memory of the host device.

2. The storage system of claim 1, wherein
operation result data consecutively stored in the main memory are consecutively written to a second storage device among the multiple storage devices with a single access in response to a data write request of the host device.

3. The storage system of claim 1, wherein
the multiple storage devices include storage devices of one type among a hard disk drive (HDD), a solid state drive (SSD), and nonvolatile memory express (NVMe).

4. The storage system of claim 1, wherein
the multiple storage devices include storage devices of one or more types among a hard disk drive, a solid state drive, and nonvolatile memory express.

5. The storage system of claim 1, wherein
the host device requests read of probability amplitude data for each of sub-circuits obtained by partitioning a quantum circuit to simulate each of the sub-circuits.

6. The storage system of claim 5, wherein
the multiple storage devices change a layout of data of each of the sub-circuits in response to a block permutation operation which is performed by the host device for each of the sub-circuits.

7. The storage system of claim 1, wherein
the processor causes the multiple storage devices to be connected to another storage system through the redundant array of independent disks (RAID) expansion card.

8. The storage system of claim 1, wherein
a bandwidth of the storage system is determined according to a number of SAS3 expansion cards connected to the multiple storage devices.

9. An operation method using multiple storage devices, the operation method comprising:
requesting, by a host device, read of data for an operation in a main memory; and
reading data consecutively stored in a first storage device among the multiple storage devices to the main memory with a single access to the first storage device,
wherein the multiple storage devices are connected to the host device through a redundant array of independent disks (RAID) expansion card.

10. The operation method of claim 9, further comprising:
consecutively writing operation result data consecutively stored in the main memory to a second storage device among the multiple storage devices with a single access in response to a data write request of the host device.

11. The operation method of claim 9, wherein
the multiple storage devices include storage devices of one type among a hard disk drive (HDD), a solid state drive (SSD), and nonvolatile memory express (NVMe).

12. The operation method of claim 9, wherein
the multiple storage devices include storage devices of one or more types among a hard disk drive, a solid state drive, and nonvolatile memory express.

13. The operation method of claim 9, wherein
the requesting of the read of the data includes requesting, by the host device, read of probability amplitude data for each of sub-circuits obtained by partitioning a quantum circuit to simulate each of the sub-circuits.

14. The operation method of claim 9, wherein
the multiple storage devices are connected to each other through the redundant array of independent disks (RAID) expansion card.

15. A computer-readable non-transitory recording medium storing a computer program including at least one instruction configured to perform, by a processor, the operation method according to claim 9 by using multiple storage devices.

16. A computer-readable non-transitory recording medium storing a computer program including at least one instruction configured to perform, by a processor, the operation method according to claim 10 by using multiple storage devices.

17. A computer-readable non-transitory recording medium storing a computer program including at least one instruction configured to perform, by a processor, the operation method according to claim 11 by using multiple storage devices.

18. A computer-readable non-transitory recording medium storing a computer program including at least one instruction configured to perform, by a processor, the operation method according to claim 12 by using multiple storage devices.

19. A computer-readable non-transitory recording medium storing a computer program including at least one instruction configured to perform, by a processor, the operation method according to claim 13 by using multiple storage devices.

20. A computer-readable non-transitory recording medium storing a computer program including at least one instruction configured to perform, by a processor, the operation method according to claim 14 by using multiple storage devices.
